(19) United States
(12) Patent Application Publication
(10) Pub. No.: US 2004/0203824 A1
(43) Pub. Date: Oct. 14, 2004

(54) Method and mobile station for determining a communication channel for a communication session

(76) Inventors: Von A. Mock, Boynton Beach, FL (US); Eric T. Eaton, Lake Worth, FL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/206,468

(22) Filed: Jul. 26, 2002

(51) Int. Cl. H04Q 7/20

(52) U.S. Cl. 455/452.1; 455/466; 455/456.1

(57) ABSTRACT

A method (500) and a mobile station (160) for determining a communication channel for a communication session are described herein. In a wireless communication system, the mobile station (160) may generate a channel list request having characteristic information associated with the mobile station (160). The characteristic information may include, but is not limited to, information associated with a device identifier, geographical location, application requirement, and capability of the mobile station (160). The mobile station (160) may transmit the channel list request to a server (330) associated with a wireless service provider via the Internet. Based on the characteristic information, the mobile station (160) may receive a channel list from the server (330). The channel list may include at least one channel operable by the mobile station for the communication session.

### TECHNICAL FIELD

The present disclosure relates to wireless communication systems, and more particularly, to a method and a mobile station for determining a communication channel for a communication session.

### BACKGROUND

As wireless technology has rapidly evolved in recent years, mobile devices such as a cellular telephone and a personal digital assistant (PDA) are playing an ever-increasing role in the lives of people throughout the world. Thus, mobile devices are developed to support more and more wireless communication protocols to accommodate for different standards that are available in the world today. That is, a mobile device may be operable to support different variations and combinations of wide area wireless communication protocols (i.e., cellular) such as Advanced Mobile Phone System (AMPS), the Narrowband Advanced Mobile Phone System (NAMPS), time division multiple access (TDMA) (e.g., D-AMPS), code division multiple access (CDMA) (e.g., CDMA 2000, CDMA IX, WCDMA), General Packet Radio Services (GPRS), Global System for Mobile Communications (GSM), Enhanced Data GSM Environment (EDGE), and Universal Mobile Telephone Service (UMTS). For example, a cellular telephone may be multi-mode to support GPRS and GSM. Other examples of combinations of protocols supported by a multi-mode cellular telephone may include CDMA and AMPS, or TDMA and GPRS.

Further, more and more short-range wireless communication protocols such as Bluetooth and Institute of Electrical and Electronics Engineers (IEEE) 802.11 (e.g., 802.11a, 802.11b) are finding their way into mobile devices. These short-range protocols offer high capacity communication channels for applications that require higher bandwidth. Businesses, hotels, cafes, restaurants, and airports are installing access points that operate in accordance with Bluetooth and IEEE 802.11b to provide, for example, Internet access to users of mobile devices. As a result, mobile devices incorporating both short-range and wide-area wireless communication technologies may be able to switch between the two technologies based on factors such as location, application requirement, and device capability. For example, a mobile device may be operable in accordance with either GPRS or IEEE 802.11b to download a movie clip. However, the user may pay a higher price to receive portions of a movie clip at a slower data rate over a GPRS network while the user may receive the entire movie clip at a faster data rate via an 802.11b link if the user had been aware that a better connection was available.

Each wireless communication protocol operates in a radio frequency (RF) band which, in turn, includes a number of RF channels. To support different RF bands such as GPRS and 802.11b as mentioned above, a mobile device may be programmed with a global scan list, which is a list of RF channels available for a communication session. Typically, the mobile device performs a search through the global scan list to determine an RF channel for a communication session (i.e., from where to obtain wireless communication service). For example, the mobile device may determine an RF channel to download the movie clip as mentioned in the above example by searching through the global scan list. However, extensive scanning for an RF channel may increase the amount of time to connect to a network and/or require the mobile device to consume more power which, in turn, reduces battery life. Further, the global scan list may increase as new wireless communication protocols are developed and/or new mobile devices are operable in accordance with multiple wireless communication protocols. Accordingly, the capacity of a memory within mobile devices may need to be increased to store the ever-increasing global scan list. Thus, the size and cost of the mobile device may also increase to accommodate for larger memory.

One aspect of designing a wireless communication system is to optimize the resources available to the wireless communication system. That is, one method of improving the availability of resources is to reduce the amount of power used by a mobile device to determine a communication channel. For example, a mobile device may be operable in accordance with either a GPRS based communication protocol or a GSM based communication protocol. Even though the mobile device may have located a GSM network earlier via a search through the global scan list, the mobile device may consume more time and power to eliminate the GSM network as a potential network for a communication session because the mobile device may have a device capability and/or an application requirement that only a GPRS network may satisfy. Therefore, a need exist to optimize communication resources to determine a communication channel for a communication session.

### BRIEF DESCRIPTION OF THE DRAWINGS

This disclosure will be described in terms of several embodiments to illustrate its broad teachings. Reference is also made to the attached drawings.

FIG. 1 is a block diagram representation of a wide area communication system.

FIG. 2 is a block diagram representation of a short-range communication system.

FIG. 3 is a block diagram representation of a global scan list.

FIG. 4 is a block diagram representation of a communication system between a mobile station and a server associated with a wireless service provider.

FIG. 5 is a block diagram representation of the mobile station.

FIG. 6 is a flow diagram illustrating a method for determining a communication channel for a communication session.

### DETAILED DESCRIPTION

A method and a mobile station for determining a communication channel for a communication session are described. In a wireless communication system, a mobile station may generate a channel list request including characteristic information associated with the mobile station. The characteristic information may include information associated with, but not limited to, a device identifier, geographical location, application requirement, and device capability of the mobile station. In particular, the mobile station may determine its geographical location in many ways that persons of ordinary skill in the art will appreciate. For example, a global positioning system (GPS) (e.g., via a satellite) or a forward link trilateration (FLT) system may provide the mobile station with information associated with geographical location of the mobile station (i.e., location information). Upon receipt of the location information (e.g., via a GPS receiving unit), the mobile station may transmit the characteristic information to a server associated with a wireless communication provider via the Internet. That is, the mobile station may access an Internet link such as a uniform resource locator (URL) and an Internet Protocol (IP) address associated with the server. The Internet link may be stored within a memory of the mobile station. Alternatively, the Internet link may be within control channel information received by the mobile station 160.

Accordingly, the mobile station may upload the characteristic information to the server via the Internet link. Based on the characteristic information provided by the mobile station, the server may generate a channel list including at least one communication channel that may be used by the mobile station for a communication session. For example, the server may provide a channel list based on the geographical location of the mobile station. Further, the server may consider other characteristic information such as, but not limited to, application requirement and device capability, to generate the channel list. Accordingly, the mobile station receives the channel list from the server to determine a communication channel for a communication session. If the channel list includes only one communication channel then the mobile station may automatically use that channel for the communication session. However, if the channel list includes more than one communication channel, the mobile station may select one of the communication channels based on the characteristic information. For example, the channel list may include four communication channels that the mobile station may use for transmitting a multimedia message. Based on the characteristic information (e.g., application requirement and/or device capability), the mobile station may select one of the four communication channels to transmit the multimedia message. As a result, the mobile station may be more efficient in determining a communication channel.

A wireless communication system is also described, and particularly, in terms of a wide area communication system (i.e., a cellular communication system) operating in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-55 Time Division Multiple Access (TDMA) digital cellular, the IS-95 Code Division Multiple Access (CDMA) digital cellular, CDMA 2000, the Personal Communications System (PCS), 3G, the General Packet Radio Service (GPRS), the Enhanced Data GSM Environment (EDGE), the Wireless Application Protocol (WAP), the Universal Mobile Telecommunications System (UMTS) and variations and evolutions of these protocols. As shown in FIG. 1, a wide area communication system 100 includes a communication network 110, and a plurality of base station controllers (BSC), generally shown as 120 and 125, servicing a total service area 130. As is known for such systems, each BSC 120 and 125 has associated therewith a plurality of base stations (BS), generally shown as 140, 142, 144, and 146, servicing communication cells, generally shown as 150, 152, 154, and 156, within the total service area 130. The BSCs 120 and 125, and base stations 140, 142, 144, and 146 are specified and operate in accordance with the applicable standard or standards for providing wireless communication services to mobile stations (MS), generally shown as 160, 162, 164, and 166, operating in communication cells 150, 152, 154, and 156, and each of these elements are commercially available from Motorola, Inc. of Schaumburg, Ill.

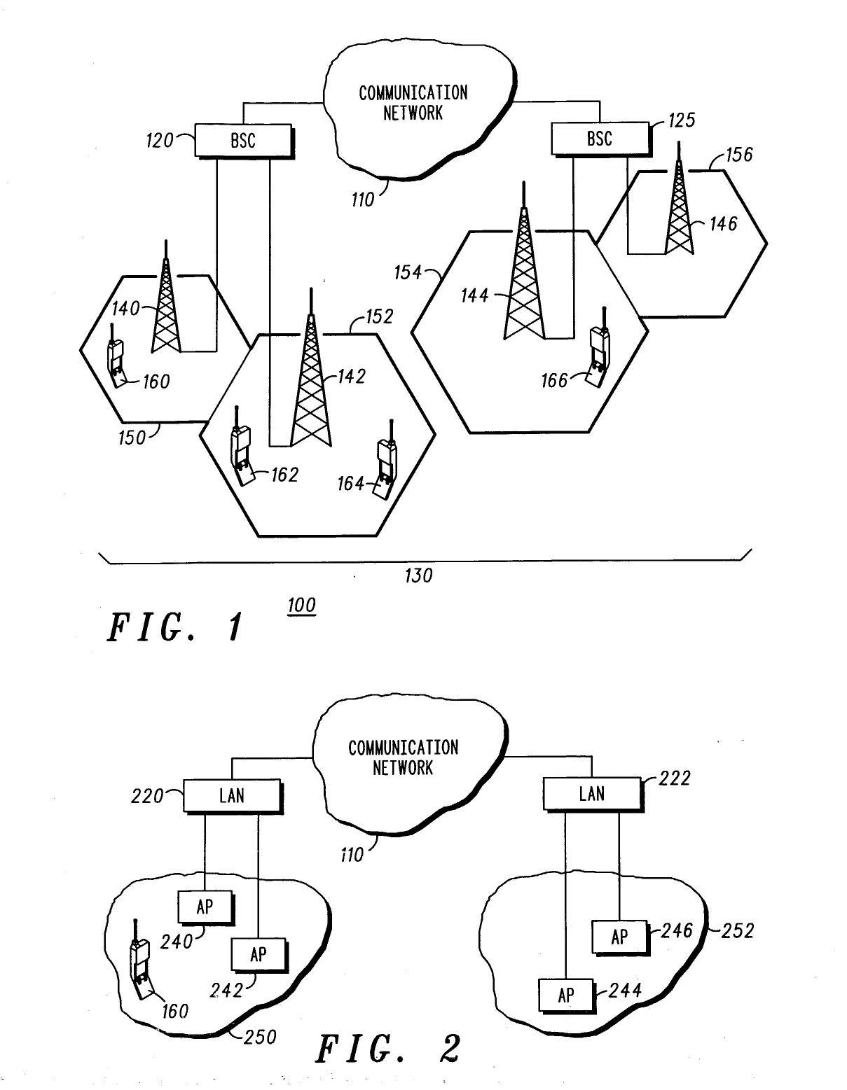

Another wireless communication system is also described, and particularly, in terms of a short-range communication system operating in accordance with at least one of several standards. These standards include short-range communication protocols such as, but not limited to, Bluetooth and Institute of Electrical and Electronics Engineers (IEEE) 802.11 (e.g., IEEE 802.11b) and variations and evolutions of these protocols. As shown in FIG. 2, a short-range communication system 200 includes the communication network 110, and a local area network (LAN), generally shown as 220 and 222. As is known for such systems, each LAN 220 and 222 has associated therewith a plurality of access points (AP), generally shown as 240, 242, 244, and 246, servicing local areas, generally shown as 250 and 252. The LANs 220 and 222, and access points 240, 242, 244, and 246 are specified and operate in accordance with the applicable standard or standards for providing wireless communication services to mobile stations (e.g., mobile station 160) operating in local areas 250 and 252.

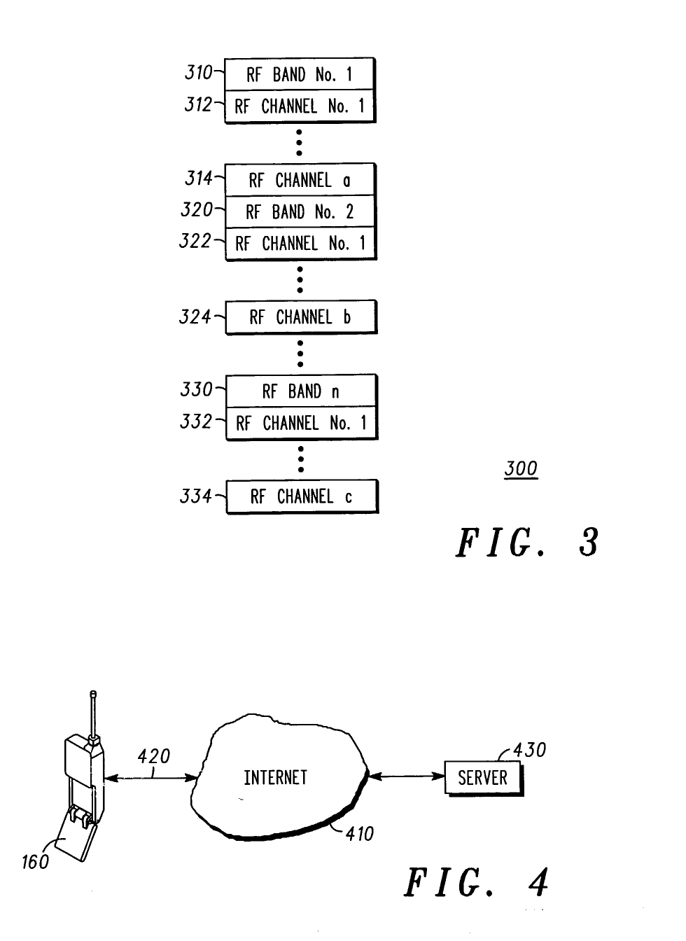

Regardless of either wide area or short-range, each wireless communication protocol operates within a radio frequency (RF) band. For example, a CDMA based communication protocol may operate in either the 800 megahertz (MHz) band or the 1.9 gigahertz (GHz) band whereas the GSM protocol may operate in either the 900 MHz band or the 1.8 GHz band. In another example, both the Bluetooth and IEEE 802.11b protocols may operate in the 2.4 GHz band. Within each RF band, a plurality of RF channels may be available for communication. For example, Bluetooth may define up to 79 RF channels with each channel having a 1 MHz bandwidth within the 2.4 GHz band (i.e., between 2.4 and 2.484 GHz) whereas IEEE 802.11b may define three non-overlapping RF channels spaced apart by 25 MHz or six overlapping RF channels spaced apart by 10 MHz within the same 2.4 GHz band. Referring to FIG. 3, for example, a global scan list 300 may include a plurality of RF bands corresponding different wireless communication protocols as mentioned above. Each of the plurality of RF bands may include a plurality of RF channels. In particular, RF BAND #1 310 may include RF CHANNEL #1 312 through RF CHANNEL a 314, RF BAND #2 320 may include RF CHANNEL #1 322 through RF CHANNEL b 324, and RF BAND n 330 may include RF CHANNEL #1 332 through RF CHANNEL c 334.

To avoid scanning through the global scan list 300, the mobile station 160 may connect to a server associated with a wireless service provider (WSP) via the Internet to determine a communication channel for a communication session. A WSP may be, but is not limited to, a company that offers communication services to users of wireless devices such as cellular telephones and personal digital assistants (PDAs) via a wireless link (e.g., a radio link). As used herein “Internet” refers to a worldwide system of computer networks (i.e., a network of networks). Although the embodiments disclosed herein are particularly well suited for use with devices such as cellular telephones, persons or ordinary skill in the art will readily appreciate that the teachings herein are in no way limited to those devices. On the contrary, persons of ordinary skill in the art will readily appreciate that the teachings can be employed with other devices such as PDAs and laptop computers.

Referring to FIG. 4, the mobile station 160 may be operatively coupled to the Internet 410 via communication link 420 to communicate with a server 430 of a WSP. The communication link 420 may be a wireless link provided by a wide area communication system (one shown as 100 in FIG. 1). For example, the mobile station 160 may communicate with the base station 140 and the BSC 120 that are operatively coupled to the communication network 110 which, in turn, provides access to the Internet 410. Alternatively, the communication link 420 may be provided by a short-range communication system such as the communication system 200 shown in FIG. 2. In particular, the mobile station 160 may communicate with the access point 240 operatively coupled to the LAN 220 which, in turn, is also operatively coupled to the communication network 110 as the base station 140 and the BSC 120. As a result, the mobile station 160 may access the Internet 410 to communicate with the server 430.

A basic flow for determining a communication channel for a communication session that may be applied with the mobile station 160 shown in FIG. 4 may start with the mobile station 160 determining its geographical location (i.e., where the mobile station 160 is located) to generate a channel list request as described in detail below. For example, the mobile station 160 may receive information associated with its geographical location from a global positioning system (GPS) (e.g., via a satellite) or a forward link trilateration (FLT) system. The geographical location may be, but is not limited to, latitude, longitude, and altitude corresponding to the location of the mobile station 160. Persons of ordinary skill in the art will appreciate that the mobile station 160 may determine its geographical location in other ways as well.

Upon determining its geographical location, the mobile station 160 may generate the channel list request to provide a WSP with characteristic information associated with mobile station 160. In particular, the characteristic information may include information associated with, but not limited to, geographical location, device identifier, application requirement, and device capability of the mobile station 160. The device identifier may be, but is not limited to, a numeric code and an alphanumeric code associated with the mobile station 160. Application requirement may be a necessary condition of an application performed by the mobile station 160 such as transmission rate. Device capability may correspond to the ability of the mobile station to support a communication session such as, but not limited to, voice call session, a conference call session, a voicemail session, an e-mail session, a short messaging service (SMS) session, a multimedia messaging service (MMS) session, an instant messaging (IM) session, and a wireless application protocol (WAP) session.

The mobile station 160 may transmit the channel list request to the server 430 associated with the WSP via the Internet 410. To communicate with the server 430, the mobile station 160 may access the Internet 410 with the communication link 420 provided by either a wide area communication system (e.g., one shown as 100 in FIG. 1) or a short-range communication system (e.g., one shown as 200 in FIG. 2) as described above. That is, the mobile station 160 may access an Internet link associated with the server 430, and upload the characteristic information to the server 430. The Internet link may be, but is not limited to, an Internet Protocol (IP) address and a uniform resource locator (URL) stored within the mobile station 160. Alternatively, the Internet link associated with the server 430 may be included in control channel information received by the mobile station 160.

Based on the characteristic information as described above, the server 430 provides a channel list of at least one communication channel to the mobile station 160. For example, the server 430 may provide a channel list based on the geographical location of the mobile station 160. To further improve quality of service, the server may also consider channel loading and availability because persons of ordinary skill in the art will appreciate that quality of service is inversely proportional to the number of devices using a communication channel. If the channel list includes only one communication channel then the mobile station 160 may automatically use that channel for communication. Alternatively, if the channel list includes a plurality of communication channels then the mobile station 160 may select one of the plurality of communication channels to use based on the characteristic information (i.e., the plurality of communication channels may be user-selectable). For example, if the channel list includes four communication channels then the mobile station 160 may select one of the four communication channels for a communication session based on application requirement and/or device capability of the mobile station 160. Further, the server 430 may provide information associated with the plurality of communication channels within the channel list to assist the user in selecting which one of the plurality of communication channels to use. For example, the information associated with the plurality of communication channels may be, but is not limited to, data rate and cost associated with each of the plurality of communication channels. In addition to providing the channel list to the mobile station 160, the server 430 may also update the global scan list 300 stored within the mobile station 160 to provide an updated global scan list of all RF channels currently available for a communication session. The updated global scan list may also provide other Internet links associated with the server 430 or other servers so that the mobile station 160 may be able to transmit other channel list requests based on its new location.

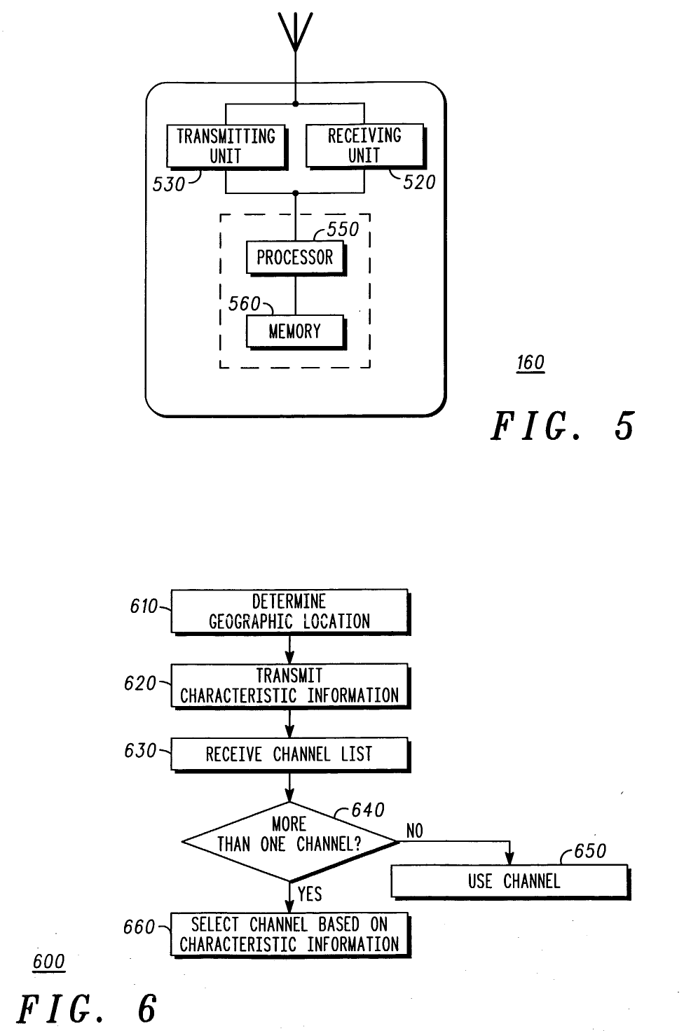

Referring to FIG. 5, a mobile station 160 adapted to determine a communication channel is shown. The mobile station 160 generally includes a controller 510, a receiving unit 520, and a transmitting unit 530. The controller 510 includes a processor 550 and a memory 560. The processor 550 is operatively coupled to the memory 560, which stores a program or a set of operating instructions for the processor 550. The processor executes the program or the set of operating instructions such that the mobile station 160 operates as described herein. The program or the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media.

One possible implementation of the computer program executed by the mobile station 160 (e.g., via the processor 550) is illustrated in FIG. 6. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 6, persons of ordinary skill in the art will appreciate that these steps can be performed in other temporal sequences. Again, the flow chart 600 is merely provided as an example of one way to program the mobile station 160 to determine a communication channel based on characteristic information. The flow chart 600 begins at step 610, wherein the mobile station 160 determines its geographical location. Persons of ordinary skill in the art will appreciate that the mobile station 160 may determine information associated with its geographical location in many ways. For example, a global positioning system (GPS) (e.g., via a satellite) or a forward link trilateration (FLT) system may provide the mobile station 160 with location information. Upon receipt of the location information (e.g., via the receiving unit 520, which may adapted to receive GPS information), the mobile station 160 at step 620 transmits a channel list request including characteristic information associated with the mobile station to a server associated with a wireless service provider via the Internet. The characteristic information may include information associated with, but not limited to, geographical location, a device identifier, application requirement, and device capability of the mobile station. For example, the mobile station 160 may access an Internet link such as a uniform resource locator (URL) and an Internet Protocol (IP) address associated with the server. Accordingly, the mobile station 160 may upload the characteristic information to the server via the Internet link. Based on the characteristic information provided by the mobile station 160, the server generates a channel list including at least one communication channel for a communication session. At step 630, the mobile station 160 receives the channel list from the server. The channel list may include only one communication channel or a plurality of communication channels. Thus, the mobile station 160 at step 640 may determine whether the channel list includes more than one communication channel. For example, the mobile station 160 may be a multi-mode cellular telephone that is operable in accordance with both a GSM based communication protocol and a GPRS based communication protocol. Accordingly, the server may provide the mobile station 160 with a list of at least communication channel that operates in accordance with either the GSM based communication protocol or the GPRS based communication protocol within the area where the mobile station 160 is located. If the channel list includes only one communication channel then the mobile station 160 at step 650 may automatically use that channel. However, if the channel list includes a plurality of channels, the mobile station 160 at step 660 may select one of the plurality of communication channels to use based on the characteristic information. That is, the mobile station 160 select one of the plurality of communication channels based on application requirement and/or device capability of the mobile station 160. As a result, the mobile station 160 may efficiently determine the best communication channel available for a communication session.

Many changes and modifications to the embodiments described herein could be made. The scope of some changes is discussed above. The scope of others will become apparent from the appended claims.

What is claimed is:

1. In a wireless communication system, a method for determining a channel for a communication session by a mobile station, the method comprising:
generating a channel list request having characteristic information associated with the mobile station;
transmitting the channel list request to a server associated with a wireless service provider via the Internet; and
receiving a channel list from the server based on the characteristic information, the channel list having at least one channel operable by the mobile station for the communication session.

2. The method of claim 1, wherein the step of generating a channel list request having characteristic information associated with the mobile station comprises generating a channel list request having information associated with one of a device identifier, geographical location, application requirement, and capability of the mobile station.

3. The method of claim 1, wherein the step of generating a channel list request having characteristic information associated with the mobile station comprises generating a channel list request including information associated with geographical location of the mobile station, the information associated with geographical location of the mobile station being received from one of a global positioning system (GPS) and a forward link trilateration (FLT) system.

4. The method of claim 1, wherein the step of transmitting the channel list request to a server associated with a wireless service provider via the Internet comprises:
accessing an Internet link associated with the server, the Internet link being one of an Internet Protocol (IP) address and a uniform resource locator (URL) stored within a memory of the mobile station; and
uploading the characteristic information to the Internet link.

5. The method of claim 1, wherein the step of transmitting the channel list request to a server associated with a wireless service provider via the Internet comprises:
receiving control channel information, the control channel information including information an Internet link associated with the server;
accessing the Internet link; and
uploading the characteristic information to the Internet link.

6. The method of claim 1, wherein the step of receiving a channel list from the server based on the characteristic information comprises receiving a channel list having at least one channel operable by the mobile station for one of a voice call session, a conference call session, a voicemail session, an e-mail session, a short messaging service (SMS) session, a multimedia messaging service (MMS) session, an instant messaging (IM) session, and a wireless application protocol (WAP) session.

7. The method of claim 1 further comprising the step of selecting one of a plurality of communication channels within the channel list based on one of the characteristic information and information associated with the plurality of communication channels, wherein the channel list includes the plurality of communication channels.

8. The method of claim 1, wherein the communication system operates in accordance with one of a code division multiple access (CDMA) based communication protocol, a time division multiple access (TDMA) based communication protocol, a general packet radio services (GPRS) based communication protocol, a global service for mobile communications (GSM) based communication protocol, an Enhanced Data GSM Environment (EDGE) based communication protocol, a Bluetooth based communication protocol, and an Institute of Electrical and Electronics Engineer (IEEE) 802.11 based communication protocol.

9. In a wireless communication system, a method for determining a communication channel, the method comprising:
determining geographical location of the mobile device;
accessing an Internet link associated with a wireless service provider;
providing the wireless service provider with the geographical location of the mobile device via the Internet link; and
retrieving a channel list from the Internet link based on the geographical location of the mobile device, the channel list having at least one communication channel for the mobile device to operate in accordance with a wireless communication protocol.

10. The method of claim 9, wherein the step of determining geographical location of a mobile station comprises receiving location information associated with the mobile station from one of a global positioning system (GPS) and a forward link trilateration (FLT) system.

11. The method of claim 9, wherein the step of accessing an Internet link associated with a wireless service provider comprises accessing one of an Internet Protocol (IP) address and an uniform resource locator (URL) associated with a wireless service provider.

12. The method of claim 9 further comprising the step of selecting one of a plurality of communication channels within the channel list based on the geographical location of the mobile device, wherein the channel list includes the plurality of communication channels.

13. The method of claim 9, wherein the wireless communication protocol is one of a code division multiple access (CDMA) based communication protocol, a time division multiple access (TDMA) based communication protocol, a general packet radio services (GPRS) based communication protocol, a global service for mobile communications (GSM) based communication protocol, an Enhanced Data GSM Environment (EDGE) based communication protocol, a Bluetooth based communication protocol, and an Institute of Electrical and Electronics Engineer (IEEE) 802.11 based communication protocol.

14. In a wireless communication system, wherein a mobile station is operable to determine a communication channel, the mobile station comprising:
a receiving unit;
a transmitting unit;
a controller operatively coupled to the receiving unit and the transmitting unit, the controller comprising a processor and a memory operatively coupled to the processor,
the controller being programmed to generate a channel list request having characteristic information associated with the mobile station;
the controller being programmed to transmit a channel list request to a server associated with a wireless service provider via the Internet; and
the controller being programmed to receive a channel list from the server based on the characteristic information, the channel list having at least one communication channel.

15. The mobile device of claim 14, wherein the controller is a controller programmed to receive information associated with geographical location of the mobile station from one of a global positioning system (GPS) and a forward link trilateration (FLT) system via the receiving unit to generate the channel list request.

16. The mobile station of claim 14, wherein the channel list request includes information associated with one of a device identifier, geographical location, application requirement, and capability of the mobile station.

17. The mobile station of claim 14, wherein the memory is operable to store an Internet link associated with the server, the Internet link being one of an Internet Protocol (IP) address and a uniform resource locator (URL), and wherein the controller is programmed to access the Internet link to transmit the channel list request to the server.

18. The mobile station of claim 14, wherein the channel list includes a plurality of communication channels, and wherein the controller is programmed to select one of a plurality of communication channels based on the characteristic information.

19. The mobile station of claim 14 is operable in accordance with one of a code division multiple access (CDMA) based communication protocol, a time division multiple access (TDMA) based communication protocol, a general packet radio services (GPRS) based communication protocol, a global service for mobile communications (GSM) based communication protocol, an Enhanced Data GSM Environment (EDGE) based communication protocol, a Bluetooth based communication protocol, and an Institute of Electrical and Electronics Engineer (IEEE) 802.11 based communication protocol.

20. In a wireless communication system, wherein a processor operates in accordance with a computer program embodied on a computer-readable medium for determining a channel for a communication session, the computer program comprising:
a first routine that directs the processor to generate a channel list request having characteristic information associated with the mobile station;
a second routine that directs the processor to transmit the channel list request to a server associated with a wireless service provider via the Internet; and
a third routine that directs the processor to receive a channel list from the server based on the characteristic information, the channel list having at least one channel operable by the mobile station for the communication session.

21. The computer program of claim 20, wherein the second routine comprises a routine that directs the processor to transmit a channel list request including information associated with one of a device identifier, geographical location, application requirement, and capability of the mobile station to a server associated with a wireless service provider via the Internet.

22. The computer program of claim 20, wherein the first routine comprises a routine that directs the processor to generate a channel list request including information associated with geographical location of the mobile station, the information associated with geographical location of the mobile station being received from one of a global positioning system (GPS) and a forward link trilateration (FLT) system.

23. The computer program of claim 20, wherein the second routine comprises a routine that directs the processor to access an Internet link associated with the server, the Internet link being one of an Internet Protocol (IP) address and a uniform resource locator (URL) stored within a memory of the mobile station, and a routine that directs the processor to upload the characteristic information to the Internet link.

24. The computer program of claim 20, wherein the second routine comprises a routine that directs the processor to receive control channel information, the control channel information including information of an Internet link associated with the server, a routine that directs the processor to access the Internet link, and a routine that directs the processor to upload the characteristic information to the Internet link.

25. The computer program of claim 20, wherein the third routine comprises a routine that directs the processor to receive a channel list having at least one channel operable by the mobile station for one of a voice call session, a conference call session, a voicemail session, an e-mail session, a short messaging service (SMS) session, a multimedia messaging service (MMS) session, an instant messaging (IM) session, and a wireless application protocol (WAP) session.

26. The computer program of claim 20 further comprising a routine that directs the processor to select one of a plurality of communication channels within the channel list based on the characteristic information, wherein the channel list includes the plurality of communication channels.

27. The computer program of claim 20 operates in accordance with one of a code division multiple access (CDMA) based communication protocol, a time division multiple access (TDMA) based communication protocol, a general packet radio services (GPRS) based communication protocol, a global service for mobile communications (GSM) based communication protocol, an Enhanced Data GSM Environment (EDGE) based communication protocol, a Bluetooth based communication protocol, and an Institute of Electrical and Electronics Engineer (IEEE) 802.11 based communication protocol.

28. The computer program of claim 20, wherein the medium is one of paper, a programmable gate array, application specific integrated circuit, erasable programmable read only memory, read only memory, random access memory, magnetic media, and optical media.
